(19) United States
(12) Patent Application Publication
(10) Pub. No.: US 2012/0311215 A1
(43) Pub. Date: Dec. 6, 2012

(54) PERIPHERAL COMPONENT INTERCONNECT EXPRESS EXPANSION SYSTEM AND METHOD

(75) Inventor: WEI-DONG CONG, Shenzhen City (CN)

(73) Assignees: HON HAI PRECISION INDUSTRY CO., LTD., Tu-Cheng (TW); HONG FU JIN PRECISION INDUSTRY(ShenZhen)CO.,LTD., Shenzhen City (CN)

(21) Appl. No.: 13/282,068

(22) Filed: Oct. 26, 2011

(30) Foreign Application Priority Data
Jun. 3, 2011 (CN) 201110149062.5

(51) Int. Cl. G06F 13/00; G06F 15/177

(52) U.S. Cl. 710/301; 713/1

(57) ABSTRACT

A peripheral component interconnect express (PCIe) expansion system used to set a motherboard PCIe slot arranged on a motherboard to work in a transmission mode with different transmission lanes includes a basic input/output system (BIOS) set on the motherboard and an expansion card. The expansion card includes a circuit board, three expansion PCIe slots arranged on the circuit board, a converting chip used to detect whether there is a device plugged into any one of the expansion PCIe slots, and an edge connector set on a side of the circuit board to be engaged in the motherboard PCIe slot. The BIOS chip used to set the transmission mode of the motherboard PCIe slot according to a detection result obtained by the converting chip.

### BACKGROUND

1. Technical Field

The present disclosure relates to a peripheral component interconnect express (PCIe) expansion system and a PCIe expansion method.

2. Description of Related Art

At present, many PCIe slots are arranged on a motherboard. A single-lane PCIe card, which is named X1-lane PCIe card, can be inserted into a multi-lane slot, such as an X4-lane slot or an X8-lane slot. However, a multi-lane PCIe slot, such as the X8-lane PCIe slot, cannot access two multi-lane PCIe cards, such as two X4-lane PCIe cards, at the same time. Thus, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a peripheral component interconnect express (PCIe) expansion system of the present disclosure.

FIG. 2 is a flowchart of an embodiment of a PCIe expansion method of the present disclosure.

### DETAILED DESCRIPTION

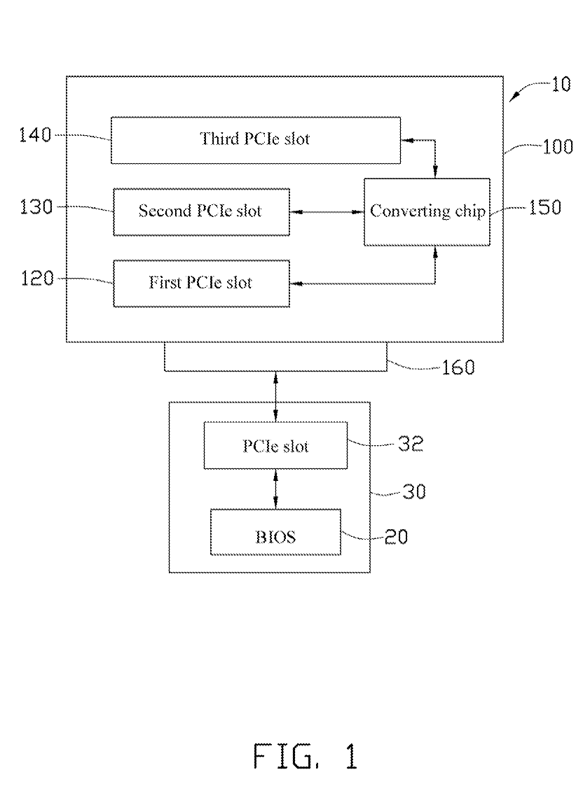

Referring to FIG. 1, an exemplary embodiment of a peripheral component interconnect express (PCIe) expansion system includes an expansion card 10, and a basic input/output system (BIOS) 20 arranged on a motherboard 30. The expansion card 10 includes a circuit board 100, a first PCIe slot 120, a second PCIe slot 130, a third PCIe slot 140, and a converting chip 150. The first to third PCIe slots 120, 130, and 140, and the converting chip 150 are all arranged on the circuit board 100. The converting chip 150 is coupled to the first PCIe slot 120, the second PCIe slot 130, and the third PCIe slot 140. An edge connector 160 is set on a side of the circuit board 100, to be engaged in a PCIe slot 32 of the motherboard 30. The first PCIe slot 120, the second PCIe slot 130, the third PCIe slot 140, and the converting chip 150 are coupled to the edge connector 160, to communicate with the PCIe slot 32 through the edge connector 160. The converting chip 150 is used to detect whether there is a device plugged into any one of the first PCIe slot 120, the second PCIe slot 130, and the third PCIe slot 140. The BIOS 20 is used to set the transmission mode of the PCIe slot 32 according to the detection result obtained by the converting chip 150.

The PCIe specification defines that a standard PCIe device can support the inter-integrated circuit (I2C) communication protocol. The standard PCIe device and the standard PCIe slot also define a present signal. If there is no device plugged into the standard PCIe slot, the voltage level of the present signal of the standard PCIe slot is high, such as logical 1, and the voltage level of the present signal of the standard PCIe slot is changed to low, such as logical 0, as the standard PCIe device is plugged into the standard PCIe slot. Therefore, the BIOS 20 can identify whether there is any device plugged into the PCIe slot 120, 130, or 140 according to the voltage level of the present signal. It can be understood that if the voltage level of the present signal of the PCIe slot 120, 130, or 140 is low, it represents that a standard PCIe device is inserted into the PCIe slot 120, 130, or 140.

In this embodiment, the first PCIe slot 120, and the second PCIe slot 130 are 4-lane (X4) PCIe slots, the third PCIe slot 140 is an 8-lane (X8) PCIe slot, the PCIe slot 32 is a 16-lane (X16) PCIe slot, and the converting chip 150 is an I2C general purpose input output (GPIO) chip.

The expansion card 10 is a non-standard PCIe device, so the voltage level of the present signal of the expansion card 10 is still high, such as logical 1, as the expansion card 10 is plugged into the PCIe slot 32. The BIOS 20 can set the PCIe slot 32 to work in a transmission mode with different transmission lanes according to the detection result obtained by the converting chip 150.

In use, a standard PCIe device is plugged into any one of the first PCIe slot 120, the second PCIe slot 130, and the third PCIe slot 140. The edge connector 160 is plugged into the PCIe slot 32. Thus, the standard PCIe device can communicate with the PCIe slot 32 through the corresponding one of the first PCIe slot 120, the second PCIe slot 130, and the third PCIe slot 140, and the edge connector 160.

When the motherboard 30 is powered on, the BIOS 20 sends instructions that support I2C communication protocol to the converting chip 150 to determine whether there is any device plugged into at least one of the PCIe slots 120, 130, and 140. When receiving the instructions, the converting chip 150 gets the voltage level of the present signals of the PCIe slots 120, 130, and 140 by its GPIO pins. If the voltage level of the present signal of at least one of the PCIe slots 120, 130, and 140 is low, the converting chip 150 obtains a result, and sends the result to the BIOS 20. The BIOS 20 sets the PCIe slot 32 to work in a corresponding transmission mode according to the result. For example, if the voltage level of the present signal of only one of the first PCIe slot 120 and the second PCIe slot 130 is low, the BIOS 20 sets the PCIe slot 32 to work in a 4-lane transmission mode. If the voltage level of the present signal of only the third PCIe slot 140 is low, the BIOS 20 sets the PCIe slot 32 to work in an 8-lane transmission mode. If the voltage level of the present signals of both of the first PCIe slot 120 and the second PCIe slot 130 is low, but the voltage level of the present signal of the third PCIe slot 140 is still high, the BIOS 20 sets the PCIe slot 32 to work in a 4-4-lane transmission mode. If the voltage level of the present signals of all of the first PCIe slot 120, the second PCIe slot 130, and the third PCIe slot 140 is low, the BIOS 20 sets the PCIe slot 32 to work in a 4-4-8-lane transmission mode. If the voltage level of the present signals of one of the first or second PCIe slots 120 or 130 and the third PCIe slot 140 is low, but the voltage level of the present signal of the other one of the first or second PCIe slots 120 or 130 is still high, the BIOS 20 sets the PCIe slot 32 to work in a 4-8-lane transmission mode.

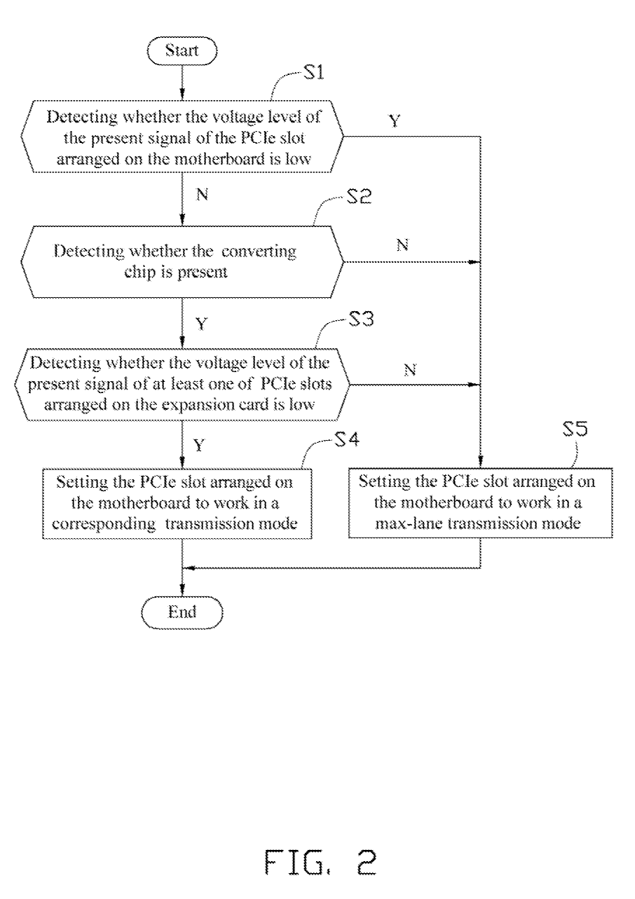

Referring to FIG. 2, a PCIe expansion method of the present disclosure includes the following steps.

In step S1, the BIOS 20 detects whether the voltage level of the present signal of the PCIe slot 32 is low. If the voltage level of the present signal of the PCIe slot 32 is low, it represents that a standard PCIe device is plugged into the PCIe slot 32, step S5 is implemented. If the voltage level of the present signal of the PCIe slot 32 is high, it represents that the standard PCIe device or the expansion card 10 is not plugged into the PCIe slot 32, step S2 is implemented.

In step S2, the BIOS 20 detects whether the converting chip 150 is present. The BIOS 20 sends instructions that support the I2C communication protocol to detect whether the PCIe slot 32 is coupled to the converting chip 150 that also supports the I2C communication protocol. If the PCIe slot 32 is coupled to the converting chip 150, it can be inferred that the expansion card 10 has been inserted into the PCIe slot 32, step S3 is implemented. Otherwise, the step S5 is implemented.

In step S3, the BIOS 20 detects whether the voltage level of the present signal of at least one of the PCIe slots 120, 130, and 140 arranged on the expansion card 10 is low. The BIOS 20 sends instructions that support I2C communication protocol to the converting chip 150 to detect whether the voltage level of the present signal of the at least one of the PCIe slots 120, 130, and 140 is low, which identifies whether a device is plugged into the PCIe slots 120, 130, or 140. If the voltage level of the present signals of all of the PCIe slots 120, 130, and 140 is still high, the step S5 is implemented. If the voltage level of the present signal of any one of the PCIe slots 120, 130, and 140 is low, step S4 is implemented.

In step 4, the BIOS 20 sets the PCIe slot 32 to work in a corresponding transmission mode. If the voltage level of the present signal of at least one of the PCIe slots 120, 130, and 140 is low, the BIOS 20 sets the PCIe slot 32 in the corresponding transmission mode. For example, if the voltage level of the present signal of only one of the first PCIe slot 120 and the second PCIe slot 130 is low, the BIOS 20 sets the PCIe slot 32 to work in a 4-lane transmission mode. If the voltage level of the present signal of only the third PCIe slot 140 is low, the BIOS 20 sets the PCIe slot 32 to work in an 8-lane transmission mode. If the voltage level of the present signals of both of the first PCIe slot 120 and the second PCIe slot 130 is low, but the voltage level of the present signal of the third PCIe slot 140 is still high, the BIOS 20 sets the PCIe slot 32 to work in a 4-4-lane transmission mode. If the voltage level of the present signals of all of the first PCIe slot 120, the second PCIe slot 130, and the third PCIe slot 140 is low, the BIOS 20 sets the PCIe slot 32 to work in a 4-4-8-lane transmission mode. If the voltage level of the present signals of one of the first or second PCIe slots 120 or 130 and the third PCIe slot 140 is low, but the voltage level of the other one of the first or second PCIe slots 120 or 130 is still high, the BIOS 20 sets the PCIe slot 32 to work in a 4-8-lane transmission mode.

In step 5, the BIOS 20 sets the PCIe slot 32 to work in a max-lane transmission mode. If there has no device plugged into the PCIe slot 32, or the expansion card 10 has been plugged into the PCIe slot 32, but the PCIe slots 120, 130, or 140 has no device accessed, the BIOS 20 sets the PCIe slot 32 to work in a 16-lane transmission mode.

In other embodiments, the first PCIe slot 120, the second PCIe slot 130, and the third PCIe slot 140 can also be X4 PCIe slots, or only two X8 PCIe slots are arranged on the expansion card 10. What is important is that the sum of the lanes of all the PCIe slots that are arranged on the expansion card 10 is less than or equal to the lanes of the PCIe slot 32.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A peripheral component interconnect express (PCIe) expansion system used to set a motherboard PCIe slot arranged on a motherboard to work in a transmission mode with different transmission lanes, the PCIe expansion system comprising:
a basic input/output system (BIOS) set on the motherboard; and
an expansion card comprising:
a circuit board;
at least one expansion card PCIe slot arranged on the circuit board;
a converting chip arranged on the circuit board to detect whether there is a device plugged into any one of the at least one expansion card PCIe slot; and
an edge connector set on a side of the circuit board to engage in the first PCIe slot;
wherein the at least one expansion card PCIe slot and the converting chip are coupled to the edge connector to communicate with the motherboard PCIe slot through the edge connector, and the BIOS sets the transmission mode of the motherboard PCIe slot according to a detection result obtained by the converting chip.

2. The PCIe expansion system of claim 1, wherein the converting chip is an inter-integrated circuit (I2C) general purpose input output (GPIO) chip.

3. The PCIe expansion system of claim 1, wherein the at least one expansion card PCIe slot comprises three expansion card PCIe slots.

4. The PCIe expansion system of claim 3, wherein a first one of the expansion PCIe slots is a 4-lane (X4) PCIe slot, a second one of the expansion PCIe slots is a 4-lane (X4) PCIe slot, a third one of the expansion PCIe slots is an 8-lane (X8) PCIe slot.

5. The PCIe expansion system of claim 3, wherein the sum of the lanes of the three expansion PCIe slots is less than or equal to the lanes of the motherboard PCIe slot.

6. The PCIe expansion system of claim 1, wherein the lanes of the at least one expansion PCIe slot are less than or equal to the lanes of the motherboard PCIe slot.

7. A peripheral component interconnect express (PCIe) expansion method used to set a motherboard PCIe slot arranged on a motherboard to work in a transmission mode with different transmission lanes, the PCIe expansion method comprising:
detecting whether the voltage level of a present signal of the motherboard PCIe slot is low by a basic input/output system (BIOS);
setting the motherboard PCIe slot to work in the max-lane transmission mode by the BIOS in response to the voltage level of the present signal of the motherboard PCIe slot being low;
detecting whether a converting chip is presented by the BIOS in response to the voltage level of the present signal of the motherboard PCIe slot being high;
setting the motherboard PCIe slot to work in the max-lane transmission mode by the BIOS in response to no converting chip being presented;
detecting whether a voltage level of the present signal of at least one expansion PCIe slot arranged on an expansion card is low by the BIOS;
setting the motherboard PCIe slot to work in the max-lane transmission mode by the BIOS in response to the voltage level of the present signal of the at least one expansion PCIe slot being high; and
setting the motherboard PCIe slot to work in a corresponding transmission mode by the BIOS in response to the voltage level of the present signal of the at least one expansion PCIe slot being low.

8. The PCIe expansion method of claim 7, wherein the converting chip is an inter-integrated circuit (I2C) general purpose input output (GPIO) chip.

9. The PCIe expansion method of claim 7, wherein the at least one expansion PCIe slot comprises three expansion PCIe slots.

10. The PCIe expansion method of claim 9, wherein a first one of the expansion PCIe slots is a 4-lane slot, a second one of the expansion PCIe slots is a 4-lane slot, and a third one of the expansion PCIe slots is an 8-lane PCIe slot.

11. The PCIe expansion method of claim 10, wherein the step of setting the motherboard PCIe slot to work in a corresponding transmission mode by the BIOS in response to the voltage level of the present signal of the at least one expansion PCIe slot being low comprises:
setting the motherboard PCIe slot to work in a 4-lane transmission mode by the BIOS in response to the voltage level of the present signal of only one of the first one and second one of the expansion PCIe slots being low;
setting the motherboard PCIe slot to work in an 8-lane transmission mode by the BIOS in response to the voltage level of the present signal of only the third one of the expansion PCIe slots being low;
setting the motherboard PCIe slot to work in a 4-4-lane transmission mode by the BIOS in response to the voltage level of the present signals of only both of the first one and second one of the expansion PCIe slots being low;
setting the motherboard PCIe slot to work in a 4-8-lane transmission mode by the BIOS in response to the voltage level of the present signals of only one of the first one and second one of the expansion PCIe slots and the third one of the expansion PCIe slots being low; and
setting the motherboard PCIe slot to work in a 4-4-8-lane transmission mode by the BIOS in response to the voltage level of the present signals of all the expansion PCIe slots being low.

12. The PCIe expansion method of claim 9, wherein the sum of the lanes of the three expansion PCIe slots is less than or equal to the lanes of the motherboard PCIe slot.

13. The PCIe expansion method of claim 7, wherein the lanes of the at least one expansion PCIe are less than or equal to the lanes of motherboard PCIe slot.
